(19) United States
(12) Patent Application Publication
(10) Pub. No.: US 2020/0258146 A1
(43) Pub. Date: Aug. 13, 2020

(54) ELECTRONIC PURCHASE ORDER GENERATION METHOD AND DEVICE, TERMINAL AND STORAGE MEDIUM

(71) Applicant: BEIJING DAJIA INTERNET INFORMATION TECHNOLOGY CO., LTD., Beijing (CN)

(72) Inventor: Yuyang XU, Beijing (CN)

(21) Appl. No.: 16/863,300

(22) Filed: Apr. 30, 2020

(30) Foreign Application Priority Data
Apr. 30, 2019 (CN) 201910365313.X

(51) Int. Cl. G06Q 30/06; G06K 9/00; H04N 21/478

(52) U.S. Cl. CPC G06Q 30/0643; G06Q 30/0633; G06K 2209/01; H04N 21/47815; G06K 9/00463

(57) ABSTRACT

Disclosed is an electronic purchase order generation method, a terminal and a storage medium. The method includes: receiving a screenshot instruction for a playing page; acquiring a screenshot picture of the playing page, and displaying an information input page in a first target area of the playing page; acquiring order information based on the information input page; and generating an electronic purchase order based on the order information and the screenshot picture.

### CROSS REFERENCE TO RELATED APPLICATION

This application claims priority to Chinese Patent Application No. 201910365313.X, filed with the Chinese Patent Office on Apr. 30, 2019. The entire disclosure of the above application is incorporated herein by reference.

### FIELD

The present disclosure relates to the field of network technology, in particular to an electronic purchase order generation method and device, a terminal and a storage medium.

### BACKGROUND

Internet live broadcast is a new form of e-commerce. Via Internet live broadcast, consumers can know the items more comprehensively and intuitively. An important part of e-commerce via Internet live broadcast is to generate orders, to complete transactions between a buyer and a seller.

At present, in the traditional order generation method of the e-commerce during Internet live broadcast, generally a buyer initiates the purchase process, while a seller, i.e., broadcast host, needs to add in advance a link of the item sold during the live broadcast to an item list, and maintain the item list, and the buyer can purchase the item by clicking on the corresponding link in the item list. However, in the above process, when the quantity of items is large, the host needs to spend a lot of time in making item links. Along with bulk replacement of the explained and sold items, the updating frequency of the item list becomes higher, and the updated contents are increased accordingly, which eventually leads to increased workload of the broadcast host in maintaining the item list and low processing efficiency of the whole process.

### SUMMARY

Embodiments of the present disclosure provide an electronic purchase order generation method and device, a terminal and a storage medium.

On one aspect, an electronic purchase order generation method is provided, the method including:

receiving a screenshot instruction for a playing page;

acquiring a screenshot picture of the playing page, and displaying an information input page in a first target area of the playing page;

acquiring order information based on the information input page; and

generating an electronic purchase order based on the order information and the screenshot picture.

In one possible implementation, the screenshot instruction is triggered by any of the following operations:

a screenshot operation;

a click operation on a target control on the playing page; and

a target gesture operation.

In one possible implementation, the target control is configured to provide a function of generating an order for the item corresponding to the playing page.

In one possible implementation, after acquiring a screenshot picture of the playing page, the method further includes any of the following steps:

identifying the screenshot picture to obtain the item price information contained in the screenshot picture; and

identifying a video stream within the target period of time before the occurrence of the screenshot instruction, to obtain the item price information indicated by the video stream.

In one possible implementation, where the step of identifying the screenshot picture to obtain the item price information contained in the screenshot picture includes any of the following steps:

performing character recognition on a second target area of the screenshot picture, to obtain a number in the second target area, and taking the number as the item price information;

performing character recognition on the screenshot picture, to obtain characters contained in the screenshot picture, and when the characters contain a target character, taking the number, having a target positional relationship with the target character, in the screenshot picture as the item price information; and

performing character recognition on the screenshot picture, to obtain characters contained in the screenshot picture, and taking the character, with the font conforming to a target font, in the characters as the item price information.

In one possible implementation, the number, having a target positional relationship with the target character, in the screenshot picture refers to any type of the following numbers:

a number, with the distance between the number and the target character being smaller than a distance threshold, in the screenshot picture;

a number, located in a target position of the target character and with a distance between the number and the target character being smaller than a distance threshold, in the screenshot picture; and

a number, separated from the target character by a target symbol, in the screenshot picture.

In one possible implementation, before performing character recognition on a second target area of the screenshot picture, to obtain a number in the second target area, and taking the number as the item price information, the method further includes any of the following steps:

taking a preset area in the screenshot picture as a second target area;

when detecting that the screenshot picture contains closed lines of a target shape, determining the area framed by the closed lines as the second target area; and

when detecting that the screenshot picture contains a target marker, determining the area corresponding to the target marker as the second target area.

In one possible implementation, the step of identifying a video stream within the target time before the occurrence of the screenshot instruction, to obtain the item price information indicated by the video stream includes:

performing speech recognition on speech data in the video stream, to obtain the item price information.

In one possible implementation, the step of performing speech recognition on speech data in the video stream, to obtain the item price information includes any of the following steps:

performing speech recognition on the speech data, and taking the number obtained from recognition as the item price information;

performing speech recognition on the speech data to obtain speech information, and taking the number appearing after the target information in the speech information as the item price information; and

performing speech recognition on the speech data, and taking a number group, with the repetition times being greater than a target number, in the characters obtained from recognition as the item price information.

In one possible implementation, the step of displaying an information input page in a first target area of the playing page includes:

displaying the information input page containing the item price information in the first target area of the playing page.

In one possible implementation, the item price information displayed in the information input page is modifiable information.

In one possible implementation, the step of acquiring order information based on the information input page includes:

detecting the input operation in the information input page, and acquiring the information input during the input operation as the order information.

In one possible implementation, the screenshot picture is configured to determine a target item from the item list corresponding to the playing page based on the screenshot picture.

In one possible implementation, the item price information in the order information is used for determining a target item from the item list corresponding to the playing page.

In one possible implementation, the playing page includes any of the following pages:

a real-time video playing page; and

a non-real-time video playing page.

In one possible implementation, after generating an electronic purchase order based on the order information and the screenshot picture, the method further includes:

sending the electronic purchase order to a server.

On a second aspect, an electronic purchase order generation device is provided, and the device includes:

a receiving module, configured to receive a screenshot instruction for a playing page;

an acquisition module, configured to acquire a screenshot picture of the playing page;

a display module, configured to display an information input page in a first target area of the playing page; and

a generation module, configured to generate an electronic purchase order based on the order information and the screenshot picture.

In one possible implementation, the screenshot instruction is triggered by any of the following operations:

a screenshot operation;

a click operation on a target control on the playing page; and

a target gesture operation.

In one possible implementation, the target control is configured to provide a function of generating an order for the item corresponding to the playing page.

In one possible implementation, the device further includes any of the following modules:

a first recognition module, configured to identify the screenshot picture to obtain the item price information contained in the screenshot picture; and

a second recognition module, configured to identify a video stream within the target period of time before the occurrence of the screenshot instruction, to obtain the item price information indicated by the video stream.

In one possible implementation, the first recognition module is configured to perform any of the following steps:

performing character recognition on a second target area of the screenshot picture, to obtain a number in the second target area, and taking the number as the item price information;

performing character recognition on the screenshot picture, to obtain characters contained in the screenshot picture, and when the characters contain a target character, taking the number, having a target positional relationship with the target character, in the screenshot picture as the item price information; and

performing character recognition on the screenshot picture, to obtain characters contained in the screenshot picture, and taking the character, with the font conforming to a target font, in the characters as the item price information.

In one possible implementation, the number, having a target positional relationship with the target character, in the screenshot picture refers to any type of the following numbers:

a number, with the distance between the number and the target character being smaller than a distance threshold, in the screenshot picture;

a number, located in a target position of the target character and with a distance between the number and the target character being smaller than a distance threshold, in the screenshot picture;

and a number, separated from the target character by a target symbol, in the screenshot picture.

In one possible implementation, the first recognition module is further configured to perform any of the following steps:

taking a preset area in the screenshot picture as a second target area;

when detecting that the screenshot picture contains closed lines of a target shape, determining the area framed by the closed lines as the second target area; and

when detecting that the screenshot picture contains a target marker, determining the area corresponding to the target marker as the second target area.

In one possible implementation, the second recognition module is configured to perform speech recognition on speech data in the video stream, to obtain the item price information.

In one possible implementation, the second recognition module is configured to perform any of the following steps:

performing speech recognition on the speech data, and taking the number obtained from recognition as the item price information;

performing speech recognition on the speech data to obtain speech information, and taking the number appearing after the target information in the speech information as the item price information;

performing speech recognition on the speech data, and taking a number group, with the repetition times being greater than a target number, in the characters obtained from recognition as the item price information.

In one possible implementation, the display module is configured to display the information input page containing the item price information in the first target area of the playing page.

In one possible implementation, the item price information displayed in the information input page is modifiable information.

In one possible implementation, the acquisition module is configured to detect the input operation in the information input page, and acquire the information input during the input operation as the order information.

In one possible implementation, the screenshot picture is configured to determine a target item from the item list corresponding to the playing page based on the screenshot picture.

In one possible implementation, the item price information in the order information is used for determining a target item from the item list corresponding to the playing page.

In one possible implementation, the playing page includes any of the following pages: a real-time video playing page and a non-real-time video playing page.

In one possible implementation, the device further includes:

a sending module, configured to send an electronic purchase order to a server.

On a third aspect, a terminal is provided. The terminal includes one or more processors and one or more memories, where the one or more memories store at least one instruction, and the instruction is loaded and executed by the one or more processors to implement the operations performed by the electronic purchase order generation method.

On a fourth aspect, a computer readable storage medium is provided. The computer readable storage medium stores at least one instruction, and the instruction is loaded and executed by the processor to implement the operations performed by the electronic purchase order generation method.

The technical solutions provided in the embodiments of the present disclosure have the following beneficial effects.

In the technical solution provided in the embodiment of the present disclosure, the terminal is triggered to generate an order of the item in the current playing page through simple operation of a seller, and the seller does not need to make multiple item links in advance as before and add the finished item links to a corresponding item list in sequence, thereby providing users with simpler and smoother order generation process, reducing time spent on order generation, and improving processing efficiency.

### BRIEF DESCRIPTION OF THE DRAWINGS

In order to more clearly illustrate technical solutions in embodiments of the present disclosure, a brief introduction will be given below on accompanying drawings which need to be used in the description of the embodiments. Apparently, the accompanying drawings described below are merely some embodiments of the present disclosure. Those skilled in the art can obtain other accompanying drawings according to these drawings without any creative effort.

FIG. 1 is an implementation environment of an electronic purchase order generation method provided in an embodiment of the present disclosure;

FIG. 2 is a flow chart of an electronic purchase order generation method provided in an embodiment of the present disclosure;

FIG. 3 illustrates a schematic diagram of a possible playing page;

FIG. 4 is a schematic diagram of an example information input page;

FIG. 5 is a schematic diagram of a second target area;

FIG. 6 is a schematic diagram of another second target area;

FIG. 7 is a schematic diagram of still another second target area;

FIG. 8 is a schematic diagram of a target character;

FIG. 9 is a schematic diagram of a character of a target font;

FIG. 10 is a structural schematic diagram of an electronic purchase order generation device provided in an embodiment of the present disclosure;

FIG. 11 is a structure diagram of a terminal 1200 provided in an exemplary embodiment of the present disclosure;

FIG. 12 is a structural schematic diagram of a computer device provided in an embodiment of the present disclosure.

### DETAILED DESCRIPTION OF THE EMBODIMENTS

In order to make the objectives, technical solutions, and advantages of the present disclosure clearer, the embodiments of the present disclosure will be described in detail below in combination with accompanying drawings.

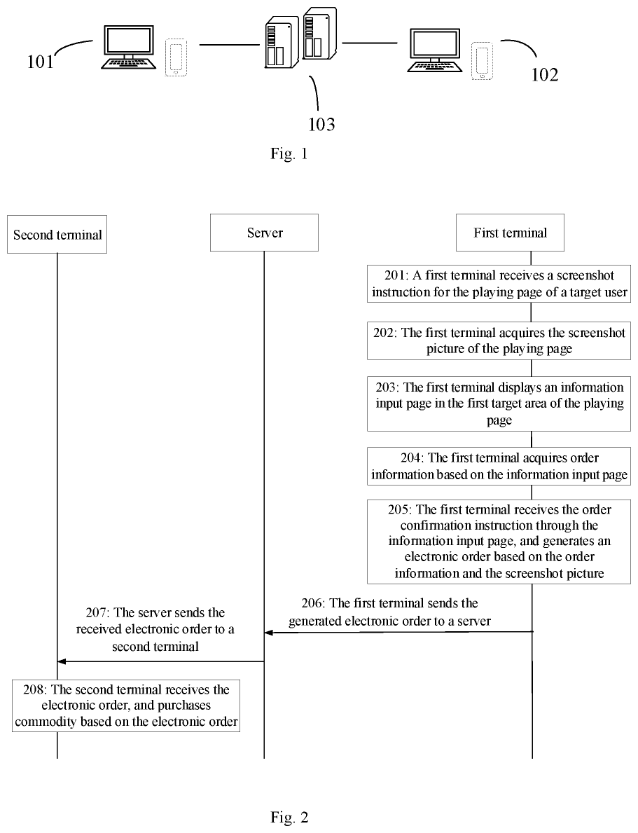

FIG. 1 is an implementation environment of an electronic purchase order generation method provided in an embodiment of the present disclosure. Please refer to FIG. 1, and in the implementation environment, there are at least one terminal 101 and at least one terminal 102. The at least one terminal 101 can be a broadcast host end device, and is configured to post live videos or finished videos. When a live video is posted, the terminal 101 can send the video stream to the at least one terminal 102, while the at least one terminal 102 can be an audience-end device, and is configured to enable the user to watch the live broadcast based on the video stream received by the terminal 102. When the finished video is posted, the terminal 101 can directly send the video to the server 103, and the server 103 provides video playing service to the terminal 102. The above terminal 101 can be a smart phone, a tablet personal computer, a portable computer, etc., while the terminal 102 can be a smart phone, a tablet personal computer, etc., which is not defined in the embodiment of the present disclosure.

Of course, the implementation environment can further include at least one server 103, and the at least one server 103 can include a server configured to provide a video service, and can further include a server configured to provide an e-commerce service. Of course, the video service and the e-commerce service can be realized through the same server, and can also be realized through different servers. With the above two services being realized through different servers as an example, when a user conducts a live video on the terminal 101, the video stream can be published to a first server in the server 103 through the network, and is distributed through the first server. After the terminal 102 receives the video stream forwarded by the first server, the video can be played based on the video stream. During the playing process, through interaction with a second server in the at least one server 103, order generation, payment and other e-commerce related operations are performed. After the user sends a finished video to the server 103 through the terminal 101, the server 103 can generate a video stream for the terminal 102 based on the video playing request of the terminal 102, and can send the video stream to the terminal 102, such that the terminal 102 can play the video.

FIG. 2 is a flow chart of an electronic purchase order generation method provided in an embodiment of the present disclosure. Please refer to FIG. 2, and the embodiment can specifically include the following steps.

Step 201, a first terminal receives a screenshot instruction for the playing page of a target user.

In an embodiment of the present disclosure, the first terminal can be an broadcast host side terminal, and the broadcast host can trigger generation of an electronic purchase order through conducting a live broadcast on the first terminal or through performing operations in the process in which the first terminal plays a video provided in the embodiment of the present disclosure.

Here, the playing page refers to a page displayed by the terminal based on the received video stream. The playing page can be a real-time video playing page, for example, a live broadcast page, and can also be a non-real-time video playing page, for example, a short video playing page. The screenshot instruction is used for instructing the terminal to take a screenshot of the image displayed on the display screen. While in the embodiment of the present disclosure, the screenshot instruction is further used for instructing to display the information input page for electronic purchase order generation.

In an embodiment of the present disclosure, the triggering manners of the screenshot instruction can include any of the multiple possible implementation manners below.

(1) the screenshot instruction can be triggered by a screenshot operation. Where, terminals of different types can correspond to different screenshot operations, for example, for the terminals of some types, the screenshot operation can be a pressing operation on multiple operation buttons simultaneously. For another example, for the terminals of another types, the screenshot operation can be a pressing operation on a certain operation button.

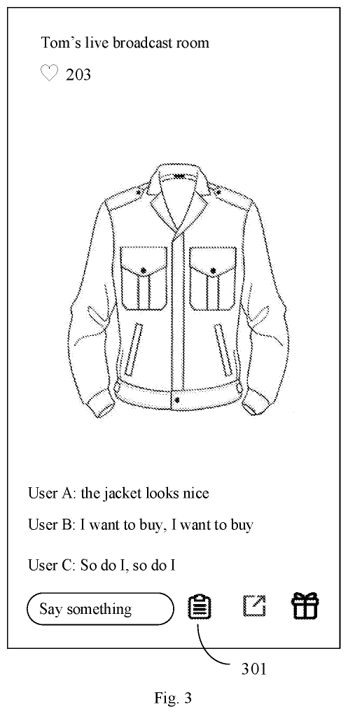

(2) the screenshot instruction can be triggered by a click operation on a target control on the playing page. Here, the target control can be an existing function control or an additional function control on the playing page, for example, the target control is configured to provide a function of purchasing the item corresponding to the playing page. When the terminal detects a click operation on the target control on the playing page, the terminal can trigger the screenshot operation for the playing page, to realize subsequent rapid purchase based on the screenshot. For example, FIG. 3 provides a schematic diagram of a possible playing page, and the schematic diagram of the playing page includes video pictures, video information, interaction information of the bullet screen, function buttons and other elements, where the shopping cart control 301 is the target control which can provide a purchasing function.

(3) the screenshot instruction can be triggered by the target gesture operation detected by the terminal. Where, the target gesture operation can be any gesture operation, the target gesture operation can be a gesture operation defaulted by an application, and can also be a gesture operation customized by a user. For example, the target gesture operation can be a sliding operation of a target moving track on the playing page, and when the terminal detects that the moving track of the sliding operation conforms to the target moving track, then the screenshot instruction is triggered. The target moving track can be a triangular track, etc., which is not defined in the embodiment of the present disclosure.

202, the first terminal acquires the screenshot picture of the playing page.

The first terminal can call the screenshot function of an operating system to take a screenshot of the playing page which is displayed currently, to obtain a screenshot picture. For example, for a playing page showing the item introduction being broadcasted, the screenshot picture can include the item being introduced, therefore, the screenshot picture can serve as a carrier used for determining an item, to be carried in the electronic purchase order and used for indicating the target item corresponding to the electronic purchase order. After any buyer purchases based on the electronic purchase order, the buyer can send a paid order to the first terminal, and the paid order can further carry the screenshot picture, to tell the broadcast host which specific item is to be delivered.

In one possible implementation, the first terminal can determine a target item from the item list corresponding to the playing page based on the screenshot picture, that is, the item for which an electronic purchase order needs to be generated, and the first terminal automatically fills the item information of the target item to the electronic purchase order.

Step 203, the first terminal displays an information input page in the first target area of the playing page.

After the screenshot instruction is received, the first terminal can also be triggered to display an information input page in the playing page, such that the user inputs item price and remarks (for example, item name, size selection interval), etc.

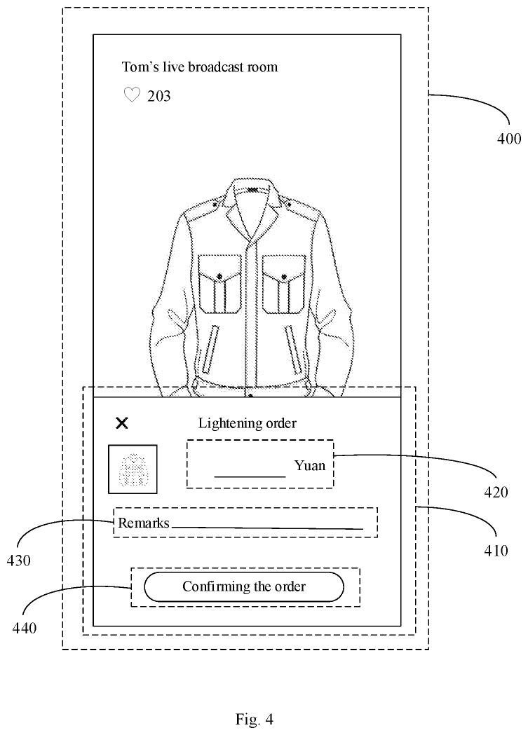

Here, the first target area can be any area of the playing page, and for example, FIG. 4 is a schematic diagram of an example information input page. With the first target area being the area in the bottom of the playing page 400 as an example, the playing page 400 includes an information input page 410, where the information input page 410 can include an item price area 420, a remark area 430 and other information input areas and a confirmation button 440, and when the confirmation button is clicked, the generation of an electronic purchase order can be triggered.

Here, the item price information is used for determining target item from the item list corresponding to the playing page, so that the user does not need to make item links in advance, and the electronic purchase order corresponding to the item can be generated by the first terminal only when the user inputs item price in the first terminal.

In the above display manner, the information input page is displayed in the first target area of the playing page without skipping to any other pages, thereby avoiding page switching during the related information being filled in by the user, such that the user can continue to conduct live broadcast while filling in information, thereby ensuring continuity of live broadcast.

Step 204, the first terminal acquires order information based on the information input page.

In the embodiment of the present disclosure, when the first terminal detects input information of the user in the information input page, the input information is acquired as order information.

Step 205, the first terminal receives the order confirmation instruction through the information input page, and generates an electronic purchase order based on the order information and the screenshot picture.

Here, the electronic purchase order can include the order information and the screenshot picture, and can also include account information of the user of the first terminal.

For each piece of information in the order information, required information and optional information can be set, to ensure to prompt the user to provide sufficient item information to complete the whole transaction, thereby avoiding transaction failure caused by insufficient item information, and improving transaction efficiency. When the first terminal receives the order confirmation instruction triggered based on the confirmation button in the information input page, the first terminal detects whether input information is included in the required area in the information input page, if no input information is included in the required area, then the step of generating an electronic purchase order is not performed, and prompt information is displayed in the required area, to prompt the user to input information in the required area; if input information is included in the required area, then step 205 is performed. For example, when the first terminal does not identify input information in the item price area in the information input page or identifies incorrect format of the input information, the first terminal does not generate the electronic purchase order and prompts the user to input information correctly.

Step 206, the first terminal sends the generated electronic purchase order to a server.

Step 207, the server sends the received electronic purchase order to a second terminal.

The server can send the electronic purchase order to the second terminal through a discussion area, such that the electronic purchase order can be displayed on the discussion area of each second terminal, and the server can also directly send the electronic purchase order to each second terminal, and then the electronic purchase order is displayed on the playing page of the terminal through each second terminal.

Step 208, the second terminal receives the electronic purchase order, and purchases item based on the electronic purchase order.

In the embodiment of the present disclosure, the second terminal can be an audience-side terminal, and the audience can purchase item in the process of watching the live broadcast or the video on the second terminal. For example, on the second terminal side, the electronic purchase order can be displayed in a form of a link, when the user clicks the link of the electronic purchase order, the electronic purchase order can be displayed in an area of the playing page, and the information input area is displayed. The user can input his receiving address and other user information in the information input area, and perform such processes as ordering and payment, to complete the purchase of item. The electronic purchase order can also be directly displayed as an information input area containing the electronic purchase order, when the second terminal receives the electronic purchase order, the information input area can directly pop up in the playing page, such that the audience user can view the electronic purchase order and fill in user information to perform the ordering and payment processes.

It should be noted that, in one possible implementation, when the server receives the electronic purchase order, the server can query an item list corresponding to the target user based on the item price information in the order information, acquire the item matched with the item price information from the item list, and verify the item based on the screenshot picture. When the item in the screenshot picture is the same as the item corresponding to the item price information, the item is taken as a target item, the item information of the target item is filled into the electronic purchase order, to make it easier for the buyer to determine item information corresponding to the electronic purchase order.

It can be seen from the above electronic purchase order generation process that, compared with the solution of generating an electronic purchase order in the related art, in the solution provided in an embodiment of the present disclosure, the terminal is triggered to generate an order of the item in the current playing page through simple operation of a seller, and the seller does not need to make multiple item links in advance as before and add the finished item links to a corresponding item list in sequence, thereby providing users with simpler and smoother order generation process, reducing time spent on order generation, and improving processing efficiency.

In an embodiment provided in the present disclosure, the terminal can automatically identify item price information, and fill the identified item price information into the item price area of the order information page in advance, while no manual input of the user is required, therefore, such an implementation manner greatly reduces involvement degree of the user, and improves intelligence of the whole order generation process. Specifically, the above process of automatically identifying the item price information can include any of the following implementation manners.

The first implementation manner: the terminal identifies an acquired screenshot picture, to obtain item price information contained in the screenshot picture.

When the terminal identifies the acquired screenshot picture, the terminal can acquire item price information contained in the screenshot picture through identifying such key information as target area, target character and target font in the screenshot picture. In some embodiments, this can be implemented through any of the following manners.

(1) the terminal performs character recognition on a second target area of the screenshot picture to obtain a number in the second target area, and takes the number as the item price information.

Item price information usually takes the form of numbers. As such, the number contained in the screenshot pictures can be identified through character recognition and is taken as item price information. To reduce the amount of character recognition processing and avoid excessive computing pressure on the terminal, the terminal can only perform character recognition on a certain area in the screenshot picture, thereby reducing possibility of error recognition. The above second target area is just the area for character recognition, and the second target area can be a preset area, in some embodiment, the area can be an area framed by closed lines or an area corresponding to the target markers.

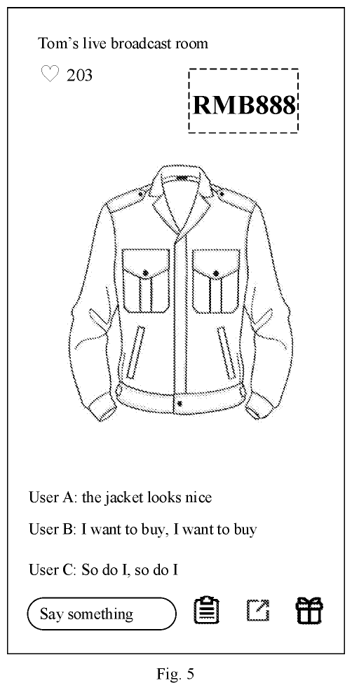

Here, the preset area is a defaulted area, position parameters of the preset area can be filled in the application configuration file of the terminal, so that when character recognition is performed, the recognition can be limited to the preset area, for example, please refer to FIG. 5, the area framed by dotted lines in FIG. 5 is the preset area. That is to say, the process of determining the second target area includes: when the terminal identifies that the screenshot picture contains a preset area, taking the preset area as the second target area.

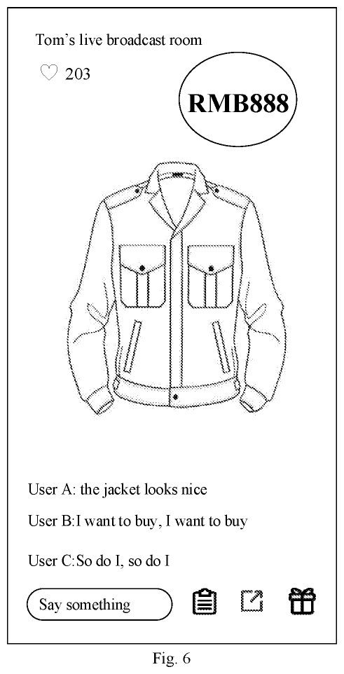

Here, the area framed by closed lines refers to an area determined based on a target shape, the server can provide the broadcast host with selections of a target shape and an area, then the broadcast host can set by herself/himself an area for character recognition, such that the item price information can be framed with these closed lines to display. For example, please refer to FIG. 6, and the area framed with an oval in FIG. 6 is just the area. That is to say, the process of determining a second target area includes: when the terminal identifies that the screenshot picture contains closed lines of the target shape, the area framed by the closed lines is determined to be the second target area.

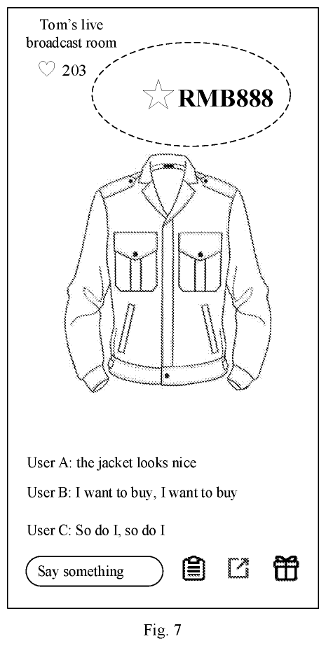

Here, the area corresponding to a target marker refers to an area determined with the target marker as a central point, and the area can be of any shape, which is not defined in the embodiment of the present disclosure. The target marker can be a marker preset by programs, for example, keywords like item price, price symbols or customized symbols. For example, please refer to FIG. 7, the area corresponding to a dotted box in FIG. 7 is just the area, and the area includes star markers. That is to say, the process of determining the second target area includes: when the terminal identifies that the screenshot picture includes a target marker, the area corresponding to the target marker is determined to be the second target area.

Any of the above manners can be adopted to determine the second target area, which is not defined in the embodiment of the present disclosure.

(2) the terminal performs character recognition on the screenshot picture, to obtain characters contained in the screenshot picture, and when the characters contain a target character, the number, having a target positional relationship with the target character, in the screenshot picture is taken as the item price information.

After the terminal obtains the characters contained in the screenshot picture, the terminal can detect whether the recognized characters include the target character based on the target character. When the target character is included, according to the display position of the target character in the screenshot picture, the terminal searches, from the recognized characters, a number with the display position thereof having a target positional relationship with the display position of the target character, and takes the number as item price information.

It should be noted that, the above process of searching a number can include: selecting candidate numbers from the recognized characters, and acquiring, from the candidate numbers, a number with the display position thereof having a target positional relationship with the display position of the target character, or the process can also include: selecting, from the recognized characters, candidate characters with the display position thereof having a target positional relationship with the display position of the target character, and determining the number from the candidate characters. The number can be obtained through any of the above searching processes, which will not be defined in the embodiment of the present disclosure.

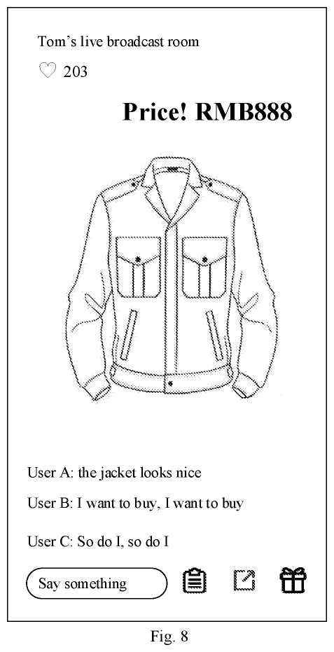

The target character can be a character set to indicate the position of item price information. For example, the target characters can be “price”, “sale”, “Price”, “ [symbol] ”, etc. Which character is specially used can be set in advance, which is not defined in the embodiment of the present disclosure. For example, please refer to FIG. 8, the “price” in FIG. 8 is just the target character, while the item price information is displayed behind the “price”.

Here, the target positional relationship can mean that the positional relationship between display positions conforms to a certain rule. For example, the target positional relationship can define a smaller distance between characters. Correspondingly, the target character can specifically include the number of any of the following types: 1. a number, with the distance between the number and the target character being smaller than a distance threshold, in the screenshot picture. 2. a number, located in a target orientation of the target character and with a distance between the number and the target character being smaller than a distance threshold, in the screenshot picture. 3. a number, separated from the target character by a target symbol, in the screenshot picture. The above distance threshold and target symbol can all be preset by programs.

(3) the terminal performs character recognition on the screenshot picture, to obtain characters contained in the screenshot picture, and takes the character, with the font conforming to a target font, in the characters as the item price information.

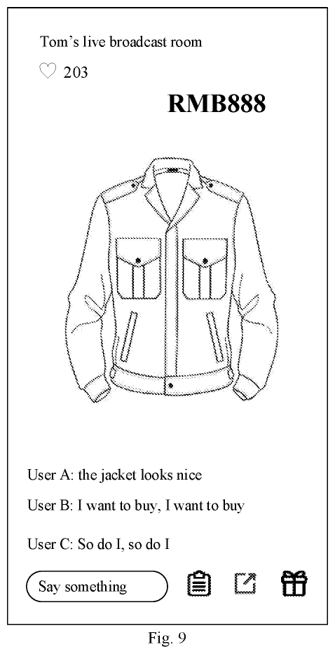

Here, the target font can be a font preset by programs, for example, a bold font, an italic font, with a certain size, in a certain color, etc., which is not defined in the embodiment of the present disclosure. Correspondingly, after the terminal obtains the characters contained in the screenshot picture, the terminal can detect whether the recognized characters include the character of the target font based on the target font. When the character of the target font is included, the character of the target font is taken as item price information. For example, please refer to FIG. 9, the font of “888” in FIG. 9 is italic.

In one possible implementation, recognition of characters in the target picture is specially realized through the following steps: firstly, the terminal can preprocess the collected screenshot picture, and reduce useless information in the image, to facilitate subsequent characteristic extraction of the screenshot pictures. Preprocessing includes graying, noise reduction, binarization, character segmentation and normalization and other sub-steps. After the screenshot picture is preprocessed, only the colors including black and white are remained in the picture, where the background of the screenshot picture is in black and the characters to be recognized are in white. Afterwards, the terminal performs characteristic extraction and dimensionality reduction on the characters to be recognized in the white area, to recognize and extract key information of the characters. The terminal classifies the characters in the classifier based on key information of the character, and obtains character classification results. The terminal optimizes the character classification results through postprocessing, for example, in the postprocessing process, character classification results acquired by the terminal can be corrected through a language model. Finally, the terminal performs character recognition based on the character classification results, and obtains character recognition results. It should be noted that, the above description of character recognition is only an exemplary introduction to a character recognition manner, and the embodiment of the present disclosure does not define which character recognition technology is specifically adopted.

It should be noted that, in the embodiment of the present disclosure, a single number with the distance between display positions being smaller than a number spacing can be taken as one number, for example, for the three characters 888, since the distance between the display positions is less than a number spacing, then 888 is recognized as one number.

The second implementation manner: after the terminal acquires the screenshot picture of the playing page, the terminal identifies a live video stream within a target period of time before the occurrence of the screenshot instruction, to obtain the item price information indicated by the live video stream.

The terminal can acquire the live video stream within the target period of time before the occurrence of the screenshot instruction, and perform speech recognition on the speech data in the live video stream, to obtain item price information based on speech recognition results.

For live broadcast, the live video stream further includes speech data, while speech data may contain item price information mentioned by the broadcast host during the introduction of the item, therefore, item price can be recognized through recognition of speech data, and the recognition process can include any of the following recognition manners.

The first recognition manner: the terminal performs speech recognition on the speech data in the live video stream, and takes the number obtained from recognition as the item price information.

When the broadcast host introduces an item, the possibility of incorrect recognition can be reduced through only mentioning the item price information once, therefore, if the terminal obtains a certain number through speech recognition, the number can be taken as item price information.

The second recognition manner: the terminal performs speech recognition on the speech data to obtain speech information, and takes the number appearing after the target information in the speech information as item price information.

In the speech data, the target information can be adopted as a cue point of item price information, when the terminal identifies that a certain number appears after the target information in the speech information, then the number obtained through recognition is taken as item price information, here the target information can be key words preset by programs, for example, price, selling price, etc.

The third recognition manner: speech recognition is performed on the speech data, and a number group, with the number of repetitions being greater than a target number, obtained from recognition is taken as the item price information.

In the speech data, the number of repetitions can also be taken as a cue point of item price information, when the terminal identifies that the number of repetitions of a certain number is greater than a target number, then the number obtained through recognition is taken as item price information, wherein the target number can be a number preset by programs.

In one possible implementation, recognition of the characters in the target picture can be specially implemented through the following steps: firstly, the terminal processes the collected target speech data, and acquires speech data containing key information. Then the terminal extracts key information in the speech data, and identifies the word of smallest unit based on the extracted key information. Finally, the terminal analyzes semantics of the whole sentence based on the above key information and the word of smallest unit, arranges key contents via sentence fragments, adjusts the text composition, modifies contents of recognition deviation according to the overall information, and generates speech recognition results. It should be noted that, the above description of speech recognition manner is only an exemplary introduction to a speech recognition manner, and the embodiment of the present disclosure does not define which speech recognition technology is specifically adopted.

It should be noted that, in the embodiment of the present disclosure, a single number, with the intervals between pronunciation moments being less than a preset interval, is taken as a number, for example, for the three characters 888, since the interval between the pronunciation moments is less than a preset interval, then 888 is recognized as one number.

The item price information can be filled to an item price area in the information input page for display in combination with the above item price information and information input page obtained through recognition. While in one possible implementation, in order to avoid transaction errors caused by recognition errors, the item price information can also be set to be modifiable information. When the item price area displayed in the information input page is incorrect, the user can update the item price information to be correct item price information through modification, thereby causing no influence on the transaction, and further providing a mechanism for correcting errors and a more flexible processing manner on the basis of filling in the price intelligently.

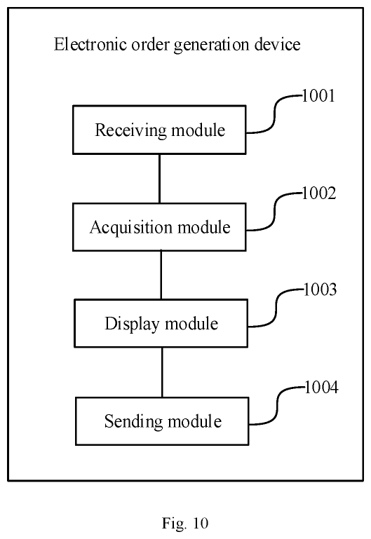

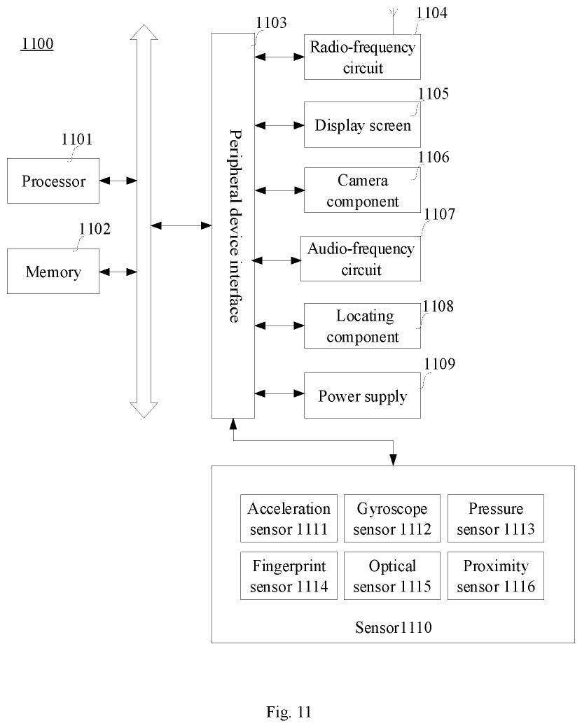

FIG. 10 is a structural schematic diagram of an electronic purchase order generation device provided in an embodiment of the present disclosure, please refer to FIG. 10, the device includes:

a receiving module 1001, configured to receive a screenshot instruction for a playing page;

an acquisition module 1002, configured to acquire a screenshot picture of the playing page;

a display module 1003, configured to display an information input page in a first target area of the playing page; and

a sending module 1004, configured to send an order generation request based on the order information and the screenshot picture.

In one possible implementation, the screenshot instruction is triggered by the screenshot operation or the click operation on the target control on the playing page.

In one possible implementation, the target control is configured to provide a function of purchasing the item corresponding to the playing page.

In one possible implementation, the device further includes any of the following modules:

a first recognition module, configured to identify the screenshot picture to obtain the item price information contained in the screenshot picture; and

a second recognition module, configured to identify a live video stream within the target period of time before the occurrence of the screenshot instruction, to obtain the item price information indicated by the live video stream.

In one possible implementation, the first recognition module is configured to perform any of the followings steps:

performing character recognition on a second target area of the screenshot picture, to obtain a number in the second target area, and taking the number as the item price information;

performing character recognition on the screenshot picture, to obtain characters contained in the screenshot picture, and when the characters contain a target character, taking the number, having a target positional relationship with the target character, in the screenshot picture as the item price information; and

performing character recognition on the screenshot picture, to obtain characters contained in the screenshot picture, and taking the character, with the font conforming to a target font, in the characters as the item price information.

In one possible implementation, the number, having a target positional relationship with the target character, in the screenshot picture refers to any type of the following numbers:

a number, with the distance between the number and the target character being smaller than a distance threshold, in the screenshot picture;

a number, located in a target orientation of the target character and with a distance between the number and the target character being smaller than a distance threshold, in the screenshot picture; and

a number, separated from the target character by a target symbol, in the screenshot picture.

In one possible implementation, the first recognition module is further configured to perform any of the followings steps:

taking a preset area in the screenshot picture as a second target area;

when detecting that the screenshot picture contains closed lines of a target shape, determining the area framed by the closed lines as the second target area; and

when detecting that the screenshot picture contains a target marker, determining the area corresponding to the target marker as the second target area.

In one possible implementation, the second recognition module is further configured to perform speech recognition on speech data in the live video stream, to obtain the item price information.

In one possible implementation, the second recognition module is further configured to perform any of the following steps:

performing speech recognition on the speech data, and taking the number obtained from recognition as the item price information;

performing speech recognition on the speech data to obtain speech information, and taking the number appearing after the target information in the speech information as the item price information;

performing speech recognition on the speech data, and taking a number group, with the repetition times being greater than a target times, in the characters obtained from recognition as the item price information.

In one possible implementation, the display module is configured to display the information input page containing the item price information in the first target area of the playing page.

In one possible implementation, the item price information displayed in the information input page is modifiable information.

In one possible implementation, the acquisition module is configured to detect the input operation in the information input page, and acquire the information input during the input operation as the order information.

In one possible implementation, the display module is further configured to: display a resource transfer page corresponding to the order information in the first target area of the playing page; when resource transfer is finished based on the resource transfer page, trigger the sending module to perform the steps of sending an order generation request based on the order information and the screenshot picture.

In one possible implementation, the screenshot picture is used for determining target item from the item list corresponding to the playing page based on the screenshot picture.

In one possible implementation, the item price information in the order information is used for determining a target item from the item list corresponding to the playing page.

All of the above optional technical solutions can be arbitrarily combined to form an optional embodiment of the present disclosure, which will not be repeated redundantly herein.

FIG. 11 shows a structural diagram of a terminal 1100 provided in an exemplary embodiment of the present disclosure. The terminal 1100 can be: a smart phone, a tablet personal computer, an MP3 (Moving Picture Experts Group Audio Layer III) player, an MP4 (Moving Picture Experts Group Audio Layer IV) player, a notebook computer or a desktop computer. The terminal 1100 may also be referred to as a user device, a portable terminal, a laptop terminal, and a desktop terminal, etc.

Generally, the terminal 1100 includes: a processor 1101 and a memory 1102.

The processor 1101 can include one or more processing cores, for example, 4-core processors and 8-core processors. The processor 1101 can be implemented in at least one hardware form selected from DSP (Digital Signal Processing), FPGA (Field-Programmable Gate Array), and PLA (Programmable Logic Array). The processor 1101 can also include a main processor and a coprocessor. The main processor is a processor to process data in a wake state, also known as a CPU (Central Processing Unit); and the coprocessor is a low power processor to process data in a standby state. In some embodiments, the processor 1101 can be integrated with a GPU (Graphics Processing Unit), and the GPU is configured to be responsible for rendering and drawing of the contents to be displayed on the display screen. In some embodiments, the processor 1101 can further include an AI (Artificial Intelligence) processor, and the AI processor is configured to handle with computing operations related to machine learning.

The memory 1102 can include one or more computer readable storage media, and the computer readable storage media can be non-transient. The memory 1102 can further include a high-speed random access memory, and a non-volatile memory, for example, one or more disk storage devices and flash memory devices. In some embodiments, the non-transient computer readable storage medium in the memory 1102 is configured to store at least one instruction, and the at least one instruction is configured to be executed by the processor 1101 to implement the electronic purchase order generation method provided in the method embodiment of the present application.

In some embodiments, the terminal 1100 can further optically include: a peripheral device interface 1103 and at least one peripheral device. The processor 1101, the memory 1102 and the peripheral device interface 1103 can be connected via a bus or a signal line. Each peripheral device can be connected with the peripheral device interface 1103 via a bus, a signal line or a circuit board. Specifically, the peripheral device includes at least one of a radio-frequency circuit 1104, a touch display screen 1105, a camera 1106, an audio-frequency circuit 1107, a locating component 1108 and a power supply 1109.

The peripheral device interface 1103 can be configured to connect at least one peripheral device related to I/O (Input/Output) to the processor 1101 and the memory 1102. In some embodiments, the processor 1101, the memory 1102 and the peripheral device interface 1103 are integrated on the same chip or circuit board; in some other embodiments, any one or two of the processor 1101, the memory 1102 and the peripheral device interface 1103 can be implemented on a single chip or circuit board, which is not defined in the present embodiment.

The radio-frequency circuit 1104 is configured to receive and transmit RF (radio frequency) signals, also known as electromagnetic signals. The radio-frequency circuit 1104 is in communication with a communication network and other communication devices through electromagnetic signals. The radio-frequency circuit 1104 converts electric signals into electromagnetic signals for transmission, or, converts the received electromagnetic signals into electric signals. Optionally, the radio-frequency circuit 1104 includes: an antenna system, an RF transceiver, one or more amplifiers, a tuner, an oscillator, a digital signal processor, a codec chipset, and a subscriber identity module card, etc. The radio-frequency circuit 1104 can be in communication with other terminals through at least one wireless communication protocol. The wireless communication protocol includes but is not limited to: a metropolitan area network, each generation of mobile communication network (2G, 3G, 4G and 5G), a wireless local area network and/or a WiFi (Wireless Fidelity) network. In some embodiments, the radio-frequency circuit 1104 can further include circuits related to NFC (Near Field Communication), which is not defined in the present application.

The display screen 1105 is configured to display a UI (User Interface). The UI can include graphics, texts, icons, videos and any combination thereof. When the display screen 1105 is a touch display screen, the display screen 1105 is further capable of collecting touch signals on or above the surface of the display screen 1105. The touch signals can be taken as control signals to be input to the processor 1101 for processing. At this time, the display screen 1105 can be further configured to provide virtual buttons and/or virtual keyboards which are also called soft buttons and/or soft keyboards. In some embodiments, one display screen 1105 can be available and is arranged on a front panel of the terminal 1100. In some other embodiments, at least two display screens 1105 can be available and are respectively arranged on different surfaces of the terminal 1100 or designed in a folding manner. In still some other embodiments, the display screen 1105 can be a flexible display screen, and is arranged on a curved surface or a fold surface of the terminal 1100. Even, the display screen 1105 can also be set to a non-rectangular irregular figure, that is, a special-shaped screen. The display screen 1105 can be prepared with such materials as LCD (Liquid Crystal Display), OLED (Organic Light-Emitting Diode), etc.

The camera component 1106 is configured to collect images or videos. Optionally, the camera component 1106 includes a front camera and a rear camera. Generally, the front camera is arranged on a front panel of the terminal, and the rear camera is arranged on a back surface of the terminal. In some embodiments, at least two rear cameras are available, which are respectively any one of a main camera, a depth-of-field camera, a wide-angle camera and a long-focus camera, so as to realize fusion of the main camera and the depth-of-field camera to achieve the background blurring function, and to realize fusion of the main camera and the wide-angle camera to achieve panoramic image capturing function and VR (Virtual Reality) image capturing function or other fusion image capturing functions. In some embodiments, the camera component 1106 can further include a flash light. The flash light can be a single-color-temperature flash light, and can also be a double-color-temperature flash light. The double-color-temperature flash light refers to a combination of a warm-light flash light and a cold-light flash light, and can be used for light compensation under different color temperatures.

The audio-frequency circuit 1107 can include a microphone and a loudspeaker. The microphone is configured to collect sound waves of the user and the environment, convert the sound waves into electric signals and input to a processor 1101 for processing, or input to a radio-frequency circuit 1104 to realize speech communication. For the purpose of stereo collection or noise reduction, multiple microphones can be available and can be respectively arranged at different parts of the terminal 1100. The microphone can also be array microphones or omnidirectional collection microphones. The loudspeaker is configured to convert electric signals from the processor 1101 or the radio-frequency circuit 1104 into sound waves. The loudspeaker can be a traditional thin film loudspeaker, and can also be a piezoelectric ceramic loudspeaker. When the loudspeaker is a piezoelectric ceramic loudspeaker, the loudspeaker not only can convert electric signals into human-audible sound waves, but also can convert electric signals into sound waves that human beings cannot hear for such applications as ranging. In some embodiments, the audio-frequency circuit 1107 can also include a headset jack.

The locating component 1108 is configured to locate the current geographic position of the terminal 1100, to realize navigation or LBS (Location Based Service). The locating component 1108 can be a locating component based on GPS (Global Positioning System) of the US, the Beidou system of China, the Glonass system of Russia, or the Galileo system of the European Union.

The power supply 1109 is configured to power each component in the terminal 1100. The power supply 1109 can be an alternating current, a direct current, a primary battery or a rechargeable battery. When the power supply 1109 includes a rechargeable battery, the rechargeable battery can support wired or wireless charging. The rechargeable battery can also be configured to support a quick charge technology.

In some embodiments, the terminal 1100 further includes one or more sensors 1110. The one or more sensors 1110 include but are not limited to: an acceleration sensor 1111, a gyroscope sensor 1112, a pressure sensor 1113, a fingerprint sensor 1114, an optical sensor 1115 and a proximity sensor 1116.

The acceleration sensor 1111 can detect the magnitude of acceleration on three coordinate axes of a coordinate system established based on the terminal 1100. For example, the acceleration sensor 1111 can be configured to detect the components of the gravitational acceleration on the three coordinate axes. The processor 1101 can control the touch display screen 1105 to display the user interface in a landscape view or portrait view according to the gravitational acceleration signals collected by the acceleration sensor 1111. The acceleration sensor 1111 can also be configured to collect movement data of games or users.

The gyroscope sensor 1112 can detect the body direction and rotating angle of the terminal 1100, and the gyroscope sensor 1112 can cooperate with the acceleration sensor 1111 to collect 3D actions of the user on the terminal 1100. The processor 1101 can realize the following functions according to the data collected by the gyroscope sensor 1112: motion sensing (for example, UI is changed according to a tilt operation of the user), image stability during image capturing, and game control and inertia navigation.

The pressure sensor 1113 can be arranged on a side frame of the terminal 1100 and/or a lower layer of the touch display screen 1105. When the pressure sensor 1113 is set on the side frame of the terminal 1100, the pressure sensor 1113 can detect holding signals of the user on the terminal 1100, and the processor 1101 performs recognition of left and right hands or shortcut actions according to holding signals collected by the pressure sensor 1113. When the pressure sensor 1113 is arranged on the lower layer of the touch display screen 1105, the processor 1101 controls operable controls on the UI interface according to the pressure operations of the user on the touch display screen 1105. The operable controls include at least one of a button control, a scroll-bar control, an icon control, and a menu control.

The fingerprint sensor 1114 is configured to collect fingerprint of a user, and the processor 1101 identifies identity of the user according to the fingerprint collected by the fingerprint sensor 1114, or, the fingerprint sensor 1114 identifies the identity of the user according to the collected fingerprint. When the identity of the user is identified to be a trusted identity, the processor 1101 authorizes the user to implement related sensitive operations, and the sensitive operations include unlocking the screen, viewing encrypted information, downloading software, paying and changing settings, etc. The fingerprint sensor 1114 can be set on a front surface, a back surface or a side surface of a terminal 1100. When the terminal 1100 is set with physical buttons or Logo of a manufacturer, the fingerprint sensor 1114 can be integrated with the physical buttons or Logo of a manufacturer.

The optical sensor 1115 is configured to collect ambient light intensity. In one embodiment, the processor 1101 can control the display brightness of the touch display panel 1105 according to the ambient light intensity collected by the optical sensor 1115. Specifically, when the ambient light intensity is relatively high, the display brightness of the touch display screen 1105 is turned up; and when the ambient light brightness is relatively low, the display brightness of the touch display screen 1105 is turned down. In another embodiment, the processor 1101 can also dynamically adjust image capturing parameters of a camera component 1106 according to the ambient light intensity collected by the optical sensor 1115.

The proximity sensor 1116, also known as a distance sensor, is generally arranged on a front panel of the terminal 1100. The proximity sensor 1116 is configured to collect the distance between the user and a front surface of the terminal 1100. In one embodiment, when the proximity sensor 1116 detects that the distance between the user and the front surface of the terminal 1100 is gradually decreased, the processor 1101 controls the touch display screen 1105 to be switched from a bright screen state to a silent screen state; when the proximity sensor 1116 detects that the distance between the user and the front surface of the terminal 1100 is gradually increased, the processor 1101 controls the touch display screen 1105 to be switched from a silent screen state to a bright screen state.

Those skilled in the art should understand that, the structure shown in FIG. 11 does not constitute a limitation to the terminal 1100, and can include more or less components than those shown in the figure, or can combine with some components, or adopt a different arrangement of components.

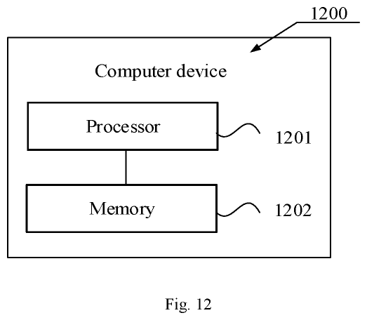

FIG. 12 is a structural schematic diagram of a computer device provided in an embodiment of the present disclosure. The computer device 1300 can vary greatly due to different configurations or performances, and can include one or more central processing units (CPUs) 1201 and one or more memories 1202, wherein the one or more memories 1202 store at least one instruction, and the at least one instruction is loaded and executed by the one or more central processing units 1201 to implement the methods provided in each of the above method embodiments. Of course, the computer device 1200 can also be provided with a wired or wireless network interface, a keyboard, an input/output interface and other components, to facilitate input and output. The computer device 1200 can further include other components configured to implement functions of the device, which is not repeated redundantly herein.

In an exemplary embodiment, a computer readable storage medium is further provided, such as a memory including instructions, and the above instruction can be executed by a processor to complete the electronic purchase order generation method in the above embodiments. For example, the computer readable storage medium can be a read-only memory (ROM), a random access memory (RAM), a compact disc read-only memory (CD-ROM), a magnetic tape, a floppy disk and an optical data storage device, etc.

Those skilled in the art should understand that, all or part of the steps for implementing the above embodiments can be completed through hardware, and can also be completed through programs which instruct related hardware to complete. The program can be stored in a computer readable storage medium, and the abovementioned storage medium can be a read-only memory, a magnetic disk or an optical disk, etc.

The above embodiments are merely preferred embodiments of the present disclosure, rather than for limiting the present disclosure. Any modification, equivalent substitution and improvement made within the spirit and principle of the present disclosure shall all fall within the protection scope of the present disclosure.

1. An electronic purchase order generation method, comprising:
receiving a screenshot instruction for a playing page;
acquiring a screenshot picture of the playing page, and displaying an information input page in a first target area of the playing page;
acquiring order information based on the information input page; and
generating an electronic purchase order based on the order information and the screenshot picture.

2. The method of claim 1, wherein the screenshot instruction is triggered by any of following operations:
a screenshot operation;
a click operation on a target control on the playing page; and
a target gesture operation.

3. The method of claim 2, wherein the target control is configured to provide a function of generating an order for an item corresponding to the playing page.

4. The method of claim 1, wherein after acquiring a screenshot picture of the playing page, the method further comprises any of following steps:
identifying the screenshot picture to obtain item price information contained in the screenshot picture; and
identifying a video stream within a target period of time before occurrence of the screenshot instruction, to obtain the item price information indicated by the video stream.

5. The method of claim 4, wherein the step of identifying the screenshot picture to obtain the item price information contained in the screenshot picture comprises any of following steps:
performing character recognition on a second target area of the screenshot picture, to obtain a number in the second target area, and taking the number as the item price information;
performing character recognition on the screenshot picture, to obtain characters contained in the screenshot picture, and when the characters contain a target character, taking a number, having a target positional relationship with the target character, in the screenshot picture as the item price information; and
performing character recognition on the screenshot picture, to obtain characters contained in the screenshot picture, and taking a character, with a font conforming to a target font, in the characters as the item price information.

6. The method of claim 5, wherein the number, having a target positional relationship with the target character, in the screenshot picture refers to any type of following numbers:
a number, with a distance between the number and the target character being smaller than a distance threshold, in the screenshot picture;
a number, located in a target orientation of the target character and with a distance between the number and the target character being smaller than a distance threshold, in the screenshot picture; and
a number, separated from the target character by a target symbol, in the screenshot picture.

7. The method of claim 5, wherein before performing character recognition on a second target area of the screenshot picture, to obtain a number in the second target area, and taking the number as the item price information, the method further comprises any of the following steps:
taking a preset area in the screenshot picture as a second target area;
when detecting that the screenshot picture contains closed lines of a target shape, determining an area framed by the closed lines as the second target area; and
when detecting that the screenshot picture contains a target marker, determining an area corresponding to the target marker as the second target area.

8. The method of claim 4, wherein the step of identifying a video stream within the target period of time before the occurrence of the screenshot instruction, to obtain the item price information indicated by the video stream comprises:
performing speech recognition on speech data in the video stream, to obtain the item price information.

9. The method of claim 8, wherein the step of performing speech recognition on speech data in the video stream, to obtain the item price information comprises any of following steps:
performing speech recognition on the speech data, and taking a number obtained from recognition as the item price information;
performing speech recognition on the speech data to obtain speech information, and taking a number appearing after the target information in the speech information as the item price information; and
performing speech recognition on the speech data, and taking a number group, with a repetition time being greater than a target number, in the characters obtained from recognition as the item price information.

10. The method of claim 4, wherein the step of displaying an information input page in a first target area of the playing page comprises:
displaying the information input page containing the item price information in the first target area of the playing page.

11. The method of claim 10, wherein the item price information displayed in the information input page is modifiable information.

12. The method of claim 1, wherein the step of acquiring order information based on the information input page comprises:
detecting an input operation in the information input page, and acquiring the information input during the input operation as the order information.

13. The method of claim 1, wherein the screenshot picture is configured to determine a target item from the item list corresponding to the playing page based on the screenshot picture.

14. The method of claim 1, wherein the item price information in the order information is used for determining a target item from the item list corresponding to the playing page.

15. The method of claim 1, wherein the playing page comprises any of following pages:
a real-time video playing page; and
a non-real-time video playing page.

16. The method of claim 1, wherein after generating an electronic purchase order based on the order information and the screenshot picture, the method further comprises:
sending the electronic purchase order to a server.

17. A terminal, comprising one or more processors and one or more memories, wherein the one or more memories store at least one instruction, and the instruction is loaded and executed by the one or more processors to implement the steps of the electronic purchase order generation method according to claim 1.

18. A computer readable storage medium, wherein the computer readable storage medium stores at least one instruction, and the instruction is loaded and executed by the processor to implement the steps of the electronic purchase order generation method according to claim 1.
